(19) United States
(12) Patent Application Publication
(10) Pub. No.: US 2022/0283798 A1
(43) Pub. Date: Sep. 8, 2022

(54) MOBILITY CONTROL SYSTEM, METHOD, AND PROGRAM

(71) Applicant: NEC Corporation, Minato-ku, Tokyo (JP)

(72) Inventor: Noritaka YAMASHITA, Tokyo (JP)

(73) Assignee: NEC Corporation, Minato-ku, Tokyo (JP)

(21) Appl. No.: 17/632,366

(22) PCT Filed: May 29, 2020
(86) PCT No.: PCT/JP2020/021377

§ 371 Date: Feb. 2, 2022

(30) Foreign Application Priority Data
Aug. 6, 2019 (JP) 2019-144749

(51) Int. Cl. G06F 8/65; G06F 8/71

(52) U.S. Cl. CPC G06F 8/65; G06F 8/71

(57) ABSTRACT

The mobility control system 80 is mounted on a mobility to be controlled and performs control according to the condition of the mobility. The software state detection unit 81 detects the state of software that controls the mobility. The control unit 82 performs a control to restrict the operating function of the mobility on the basis of the state of the software. Further, the software state detection unit 81 detects the version information or update status of the software as the state of the software, and the control unit 82 determines the function to be restricted on the basis of the state of the software.

### TECHNICAL FIELD

The present invention relates to a mobility control system, a mobility control method, and a mobility control program for performing control according to status of a mobility equipped with software.

### BACKGROUND ART

In recent years, mobility represented by cars has been equipped with communication functions to improve comfort and safety. In addition, by connecting to the Internet, it has become possible to enjoy various information services from outside in addition to what can be realized only within the mobility internal network. In this specification, mobility is defined as meaning a transportation means (for example, a vehicle such as a car).

A lot of software is used to control mobility. For example, various processes are realized using software, such as processes to realize the above-mentioned communication functions, processes to control various functions of mobility, and processes to detect abnormalities.

For example, patent literature 1 describes a system that takes action when an abnormality in communication data in an in-vehicle system occurs. The system described in patent literature 1 collects information for determining the status from each information processing device in the in-vehicle system when an abnormality in communication data occurs in the in-vehicle system, and identifies whether or not a security abnormality and a safety abnormality have occurred, respectively. Then, the above-described system determines the action to be taken for the abnormality, and notifies each information processing device thereof.

Also, Patent literature 2 describes a system for diagnosing a vehicle abnormality in real time by transmitting diagnostic target data to a center device. In the system described in patent literature 2, when the diagnostic vehicle device transmits the detected diagnostic target data to the center device, the center device determines whether the event is a rare event or not, determines whether the diagnostic vehicle is abnormal or not based on the determination result, and transmits the diagnosis result to the diagnostic vehicle device.

### CITATION LIST

### Patent Literature

Patent Literature 1: Japanese Patent Laid-Open No. 2019-73102

Patent Literature 2: Japanese Patent Laid-Open No. 2013-120143

### SUMMARY OF INVENTION

### Technical Problem

On the other hand, the systems described in patent literature 1 and patent literature 2 assume that the software for performing various processes is always available. In other words, the systems described in patent literature 1 and patent literature 2 do not consider the case where the state of the software itself changes in any way. Therefore, when mobility is controlled using software, it is desired to perform appropriate control according to the state of the software.

Therefore, it is an object of the present invention to provide a mobility control system, a mobility control method, and a mobility control program capable of performing control the mobility appropriately according to the state of the software used to control the mobility.

### Solution to Problem

A mobility control system according to the present invention is a mobility control system which is mounted on a mobility to be controlled and performs control according to condition of the mobility includes a software state detection unit which detects state of software that controls the mobility, and a control unit which performs the control to restrict an operating function of the mobility based on the state of the software, wherein the software state detection unit detects version information or update status of the software as the state of the software, and the control unit determines the function to be restricted based on the state of the software.

A mobility control method according to the present invention is a mobility control method which performs control according to condition of a target mobility includes detecting version information or update status of software as state of the software, and performing the control to restrict an operating function of the mobility based on the state of the software.

A mobility control program according to the present invention is a mobility control program applied to a computer which is mounted on a mobility to be controlled and performs control according to condition of the mobility, causes the computer to execute a software state detection process of detecting state of software that controls the mobility, and a control process of performing the control to restrict an operating function of the mobility based on the state of the software, wherein the mobility control program causes the computer to detect version information or update status of the software as the state of the software, in the software state detection process, and the mobility control program causes the computer to determine the function to be restricted based on the state of the software, in the control process.

### Advantageous Effects of Invention

According to the present invention, it is possible to perform control a mobility appropriately according to state of software used to control the mobility.

### BRIEF DESCRIPTION OF DRAWINGS

FIG. 1 It depicts a block diagram showing a configuration example of an exemplary embodiment of a mobility control system according to the present invention.

FIG. 2 It depicts a flowchart showing an operation example of a mobility control system.

FIG. 3 It depicts a block diagram showing an overview of a mobility control system according to the present invention.

### DESCRIPTION OF EMBODIMENTS

Hereinafter, exemplary embodiments of the present invention are described with reference to the drawings.

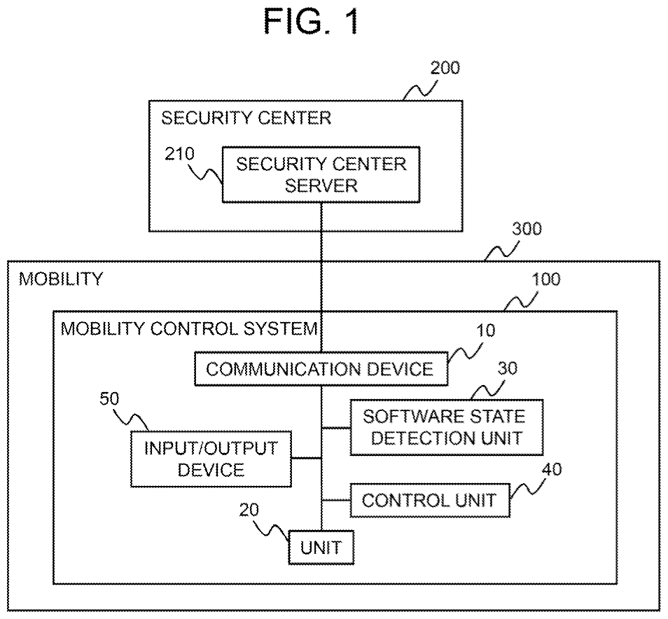

FIG. 1 is a block diagram showing a configuration example of an exemplary embodiment of a mobility control system according to the present invention. The mobility control system 100 of this exemplary embodiment includes a communication device 10, a unit 20, a software state detection unit 30, a control unit 40, and an input/output device 50.

The mobility control system 100 is a system that is mounted on a mobility 300 to be controlled and takes actions according to the condition of the mobility 300. A connected car is a specific example of the mobility 300. In this exemplary embodiment, an automatic driving car using a communication function is assumed, and the software used in the communication device 10 and the unit 20 can be updated by OTA (Over the Air). In this exemplary embodiment, various functions of an automatic driving car that uses a Global Positioning System (GPS), road-mounted device, and the Internet, and the like will be described as specific examples. However, the mobility 300 is not restricted to a car, and may be, for example, a train, an aircraft, and the like.

The mobility control system 100 communicates with a security center server 210 in the external security center 20 through the communication device 10. The security center server 210 transmits information necessary for controlling the mobility and information on software to the mobility control system 100.

The communication device 10 is specifically a device that communicates with the security center server 210 or any external server (not shown). The mode of the communication device 10 is arbitrary, and is realized, for example, by a communication device equipped with a module dedicated for in-vehicle use. The communication device 10 may notify the software state detection unit 30 described below of the communication status and software information notified by the external device.

The unit 20 is a unit that detects various states of the mobility and performs control, and is realized, for example, by various electronic control units. Although only one unit 20 is illustrated in FIG. 1, the number of units 20 is not limited to one, and may be two or more. The mobility control system 100 includes a plurality of unit 20 according to a control target. For example, in the case of a car, the control target includes an engine, a brake, a meter, a car navigation system, an airbag, and the like.

In addition, the unit 20 of this exemplary embodiment may be realized by a processor of a computer (for example, a CPU (Central Processing Unit), or a GPU (Graphics Processing Unit)) that operates according to software for various controls of mobility.

The software types include software that controls telematics, software that controls driving, software that controls automatic driving, and the like. The control targets for driving include the engine, brakes, steering wheel, and the like. As control targets for automatic driving, cameras, inter-vehicle sensors, GPS, and the like are mentioned. The above-described classifications of software types are exemplary and may be classified individually according to the software.

When the car is during driving, the software that controls the telematics described above is normally permitted to be updated during manual driving or limited automatic driving (for example, automatic driving to the range that the communication function is not used). Also, software that controls driving is usually not allowed to be updated during driving. Also, software that controls automatic driving is allowed to be updated during manual driving.

The software state detection unit 30 detects the state of the software that controls the mobility. Specifically, the software state detection unit 30 detects the state of the software used in the communication device 10 and the unit 20 that controls various states of the mobility. The software state detection unit 30 may detect the state of the software by periodically inquiring the state of the software from the unit 20, and may detect the state of the software based on the status notified by the unit 20. In addition, when the status detection unit 30 receives a notification of information (for example, update information) from an external device (for example, security center server 210), the state of the software may be detected.

The software state detection unit 30 detects, as the state of the software, version information of the software or update status of the software within the mobility control system 100. As the update status of the software, the software is currently being updated, is waiting for an update, is failing to be updated, or the like.

The software state detection unit 30 detects, as the version information of the software, whether the target software is the latest version. If the software is not the latest (is an older version), the software state detection unit 30 may further detect whether the software is vulnerable.

The software state detection unit 30 may periodically inquire the update information of the software used by the mobility control system 100 and information indicating the presence or absence of a vulnerability from an external device (for example, security center server 210) through the communication device 10, and may irregularly receive update information from the manufacturer of the software. The software state detection unit 30 may then detect the state of the software currently in use based on the software update information or the information indicating the presence or absence of a vulnerability obtained from the external device.

The control unit 40 performs control to restrict the operating functions of the mobility 300 based on the state of software detected by the software state detection unit 30. Specifically, the control unit 40 determines a function to be restricted based on the state of software, and performs various controls for the determined function.

When it is detected that the software is not the latest version, the control unit 40 notifies the user of a recommendation to update to the latest version. In addition, if the software is vulnerable software, the control unit 40 may notify the user with a stronger recommendation to update to the latest version, and may also control to restrict functions according to the part of the vulnerability. In this way, by restricting the functions according to a part of the vulnerability, it is possible to restrict only the targeted functions while suppressing the impact on other functions operated by the software having vulnerabilities in some of the functions.

In this case, the control unit 40 may also perform the same functional restrictions on the functions according to the part of the vulnerability as are performed during the software update. The control unit 40 may, for example, control the input/output device 50 described below to output a message that the software needs to be updated.

When a status in which the software is being updated is detected, the control unit 40 performs control to restrict the function according to the updated part. For example, the software controlling the telematics performs a process of sending and receiving various information necessary for driving by using a communication function. Therefore, when the software controlling the telematics is being updated, the control unit 40 may perform control to restrict the functions of the communication device.

For example, it is dangerous to operate the car while the software that controls the driving is being updated. Therefore, when the software controlling the driving is being updated, the control unit 40 may perform control to restrict various functions so that the car cannot be derived. In this case, the control unit 40 may control the software so that the software cannot be updated until the car is stopped.

For example, it is dangerous to perform automatic driving when the software controlling the automatic driving is being updated. Therefore, when the software controlling the automatic driving is being updated, the control unit 40 may perform control to restrict the functions for performing the automatic driving, and may perform the manual driving.

When a status in which the software is waiting for an update is detected, the control unit 40 performs control to notify the user that the update will change the operational function (driving mode) of the mobility, and also performs control according to whether or not the software to be updated is vulnerable. Specifically, if the software waiting for the update is found to have a vulnerability, the control unit 40 performs control to restrict the function according to the part of the vulnerability.

When a status in which the software update is failing is detected, the control unit 40 performs control to notify the user that the update has failed and to urge the user to re-update the software, and performs the same control as during the update waiting period. That is, along with the above notification, the control unit 40 performs control according to the presence or absence of vulnerability of the software to be updated.

In the case of waiting for an update or failing to update, the control unit 40 may notify the user to confirm whether to start the update automatically or not.

The input/output device 50 is a device for performing input/output processing between an operator of the mobility 300 and the mobility control system 10. The input/output device 50 is realized, for example, by an IVI (in-vehicle infotainment). The input/output device 50 may output the update status of the software and the control content by the control unit 40 in response to an instruction from the control unit 40.

The software state detection unit 30 and the control unit 40 are realized by a processor of a computer (for example, a CPU (Central Processing Unit), or a GPU (Graphics Processing Unit)) that operates according to a program (mobility control program).

For example, the program may be stored in a storage unit (not shown) comprised by the mobility control system 100, and the processor may read the program and, operate as the software state detection unit 30 and the control unit 40 according to the program. Also, the functions of the mobility control system 100 may be provided in a SaaS (Software as a Service) format.

The software state detection unit 30 and the control unit 40 may each be realized by dedicated hardware. Some or all of the components of each device may be realized by general-purpose or dedicated circuitry, processors, or combinations thereof. These may comprise a single chip or a plurality of chips connected through a bus. Some or all of the components of each device may be realized by a combination of the above-described circuits, etc. and a program.

When some or all of each component of the mobility control system 100 is realized by a plurality of information processing devices, circuits, or the like, the plurality of information processing devices, circuits, or the like may be centrally located or distributed.

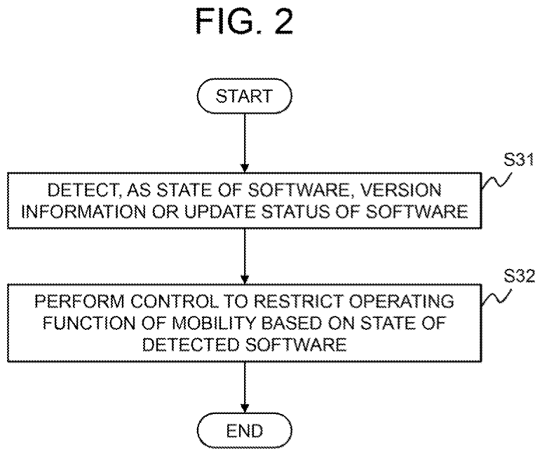

Next, an operation example of this exemplary embodiment will be described. FIG. 2 is a flowchart showing an operation example of the mobility control system 100 of this exemplary embodiment. The software state detection unit 30 detects, as a state of the software, version information or update status of the software (step S31). The control unit 40 performs control to restrict an operating function of the mobility based on the state of the detected software (step S32).

As described above, in the present exemplary embodiment, the software state detection unit 30 detects version information or update status of the software as the state of the software and the control unit 40 performs the control to restrict an operating function of the mobility based on the state of the software. Thus, it is possible to control a mobility appropriately according to the state of the software used to control the mobility.

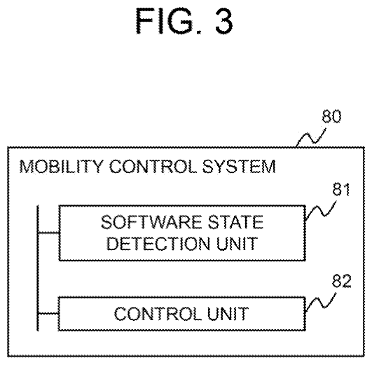

Next, an overview of the present invention will be described. FIG. 3 is a block diagram showing an overview of a mobility control system according to the present invention. The mobility control system 80 according to the present invention is a mobility control system (for example, mobility control system 100) which is mounted on a mobility (for example, mobility 300) to be controlled and performs control according to condition of the mobility includes a software state detection unit 81 (for example, software state detection unit 30) which detects state of software that controls the mobility, and a control unit 82 (for example, control unit 40) which performs the control to restrict an operating function of the mobility based on the state of the software.

The software state detection unit 81 detects version information or update status of the software as the state of the software, and the control unit 82 determines the function to be restricted based on the state of the software.

With such a configuration, it is possible to control the mobility appropriately according to the state of the software used to control the mobility.

Also, the software state detection unit 81 may detect the update status of the software as the state of the software, and the control unit 82 may perform the control to restrict the function according to updated part when the software state detection unit 81 detects status of updating. With such a configuration, it is possible to suppress changes in functions that are impacted by the update in advance.

Also, the software state detection unit 81 may detect presence or absence of software vulnerability as the state of the software, and the control unit 82 may perform the control to restrict the function according to a part of the vulnerability. With such a configuration, it is possible to suppress the occurrence of unexpected operations based on functions that have vulnerabilities.

Also, the software state detection unit 81 may detect that software is waiting for the update or that software failed to be updated as the state of the software, and the control unit 82 may perform the control to restrict the function according to a part of the vulnerability contained in the software that is waiting for the update or the software that failed to be updated. With such a configuration, it is possible to suppress unexpected operations based on functions that have vulnerabilities that may occur before the update is performed.

Also, the mobility may be a connected car which performs automatic driving. In this case, the software state detection unit 81 may detect the state of the software currently in use based on software update information or information indicating the presence or absence of the vulnerability obtained from an external device.

Also, in this case, the software state detection unit 81 may detect the update status of the software as the state of the software, and the control unit 82 may perform the control to restrict the function to perform the automatic driving when the software state detection unit 81 detects status of updating. With such a configuration, it is possible to suppress unexpected operations that impact automatic driving.

Although the present invention has been described with reference to the foregoing exemplary embodiments and examples, the present invention is not limited to the foregoing exemplary embodiments and examples. Various changes understandable by those skilled in the art can be made to the structures and details of the present invention within the scope of the present invention.

This application is based upon and claims the benefit of priority from Japanese patent application No. 2019-144749, filed on Aug. 6, 2019, the disclosure of which is incorporated herein in its entirety by reference.

### REFERENCE SIGNS LIST

10 Communication device
20 Unit
30 Software state detection unit
40 Control unit
50 Input/output device
100 Mobility control system
200 Security center
210 Security center server
300 Mobility

What is claimed is:

1. A mobility control system which is mounted on a mobility to be controlled and performs control according to condition of the mobility, the mobility control system comprising:
a memory storing instructions; and
one or more processors configured to execute the instructions to:
detect version information or update status of software that controls the mobility as state of the software;
determine an operating function to be restricted based on the state of the software; and
perform the control to restrict the operating function of the mobility.

2. The mobility control system according to claim 1, wherein the processor further executes instructions to:
detect the update status of the software as the state of the software; and
perform the control to restrict the function according to updated part when status of updating is detected.

3. The mobility control system according to claim 1, wherein the processor further executes instructions to:
detect presence or absence of software vulnerability as the state of the software; and
perform the control to restrict the function according to a part of the vulnerability.

4. The mobility control system according to claim 1, wherein the processor further executes instructions to:
detect that software is waiting for the update or that software failed to be updated as the state of the software; and
perform the control to restrict the function according to a part of the vulnerability contained in the software that is waiting for the update or the software that failed to be updated.

5. The mobility control system according to claim 1, wherein
the mobility is a connected car which performs automatic driving, and
the processor further executes instructions to detect the state of the software currently in use based on software update information or information indicating the presence or absence of the vulnerability obtained from an external device.

6. The mobility control system according to claim 5, wherein
detect the update status of the software as the state of the software; and
perform the control to restrict the function to perform the automatic driving when status of updating is detected.

7. A mobility control method which performs control according to condition of a target mobility, the mobility control method comprising:
detecting version information or update status of software as state of the software; and
performing the control to restrict an operating function of the mobility based on the state of the software.

8. The mobility control method according to claim 7, wherein
detecting the update status of the software as the state of the software, and
performing the control to restrict the function according to updated part when status of updating is detected.

9. A non-transitory computer readable information recording medium storing a mobility control program applied to a computer which is mounted on a mobility to be controlled and performs control according to condition of the mobility, when executed by a processor, the mobility control program performs a method for:
detecting version information or update status of software that controls the mobility as state of the software;
determining an operating function to be restricted based on the state of the software; and
performing the control to restrict the operating function of the mobility.

10. The non-transitory computer readable information recording medium according to claim 9, wherein
detecting the update status of the software as the state of the software, and
performing the control to restrict the function according to updated part when status of updating is detected.
